(19) United States
(12) Patent Application Publication
(10) Pub. No.: US 2003/0229710 A1
(43) Pub. Date: Dec. 11, 2003

(54) Method for matching complex patterns in IP data streams

(75) Inventors: Milton Andre Lie, McKinney, TX (US); Yu Xia, Richardson, TX (US); Darren Bensley, McKinney, TX (US)

Correspondence Address: Craig J. Cox, NETRAKE CORPORATION, Suite 100, 3000 Technology Drive, Plano, TX, 75074, US

(73) Assignee: Netrake Corporation, Plano, TX

(21) Appl. No.: 10/166,914

(22) Filed: Jun. 11, 2002

(51) Int. Cl. G06F 15/16

(52) U.S. Cl. 709/231

(57) ABSTRACT

A method is described for matching complex patterns in internet protocol (IP) data streams. The method associates each data packet with a specific flow in the IP data stream. The packet is broken into fixed length contexts and state information for that flow is retrieved. The method then determines using a data base of known signatures and the state information whether there is a potential match between the incoming data stream and a signature in the database of known signatures. If a potential match is found the method then determines whether there is an exact match between the potential signature and the incoming data stream. The state information is then updated to reflect the outcome of the scanning. When and exact match is found a conclusion is reached that determines the treatment for the incoming data stream. The state information allows the pattern matching engine to match patterns across packet boundaries and to perform complex matches.

### TECHNICAL FIELD OF THE INVENTION

The present invention relates to broadband data networking equipment. Specifically, the present invention relates to a method for matching complex patterns within internet protocol (IP) data streams using a pattern matching engine according to the present invention.

### BACKGROUND OF THE INVENTION

The character and requirements of networks and networking hardware are changing dramatically as the demands on networks change. Not only is there an ever-increasing demand for more bandwidth, the nature of the traffic flowing on the networks is changing. With the demand for video and voice over the network in addition to data, end users and network providers alike are demanding that the network provide services such as quality-of-service (QoS), traffic metering, and enhanced security. However, the existing Internet Protocol (IP) networks were not designed to provide such services because of the limited information they contain about the nature of the data passing over them.

Existing network equipment that makes up the infrastructure was designed only to forward data through the network's maze of switches and routers without any regard for the nature of the traffic. The equipment used in existing networks, such as routers, switches, and remote access servers (RAS), are not able to process any information in the network data stream beyond the packet headers and usually only the headers associated with a particular layer of the network or with a set of particular protocols. Inferences can be made about the type of traffic by the particular protocol, or by other information in the packet header such as address or port numbers, but high-level information about the nature of the traffic and the content of the traffic is impossible to discern at wire speeds.

In order to better understand packet processing and the deficiencies of existing network equipment it is helpful to have an understanding of its basic operation. The functionality of most network equipment can be broken down into four basic components. The first component is the physical layer interface (PHY layer) which converts an analog waveform transmitted over a physical medium such as copper wire pairs, coaxial cable, optical fiber, or air, into a bit stream which the network equipment can process, and vice versa. The PHY layer is the first or last piece of silicon that the network data hits in a particular device, depending on the direction of traffic. The second basic functional component is the switch fabric. The switch fabric forwards the traffic between the ingress and egress ports of a device across the bus or backplane of that device. The third component is host processing, which can encompass a range of operations that lie outside the path of the traffic passing thought a device. This can include controlling communication between components, enabling configuration, and performing network management functions. Host processors are usually off-the-shelf general purpose RISC or CISC microprocessors.

The final component is the packet processing function, which lies between the PHY layer and the switch fabric. Packet processing can be characterized into two categories of operation, those classified as fast-path and those classified as slow-path. Fast-path operations are those performed on the live data stream in real time. Slow-path operations are performed outside the flow of traffic but are required to forward a portion of the packets processed. Slow-path operations include unknown address resolution, route calculation, and routing and forwarding table updates. Some of the slow-path operations can be performed by the host processor if necessary.

For a piece of network equipment to be useful and effective, the vast majority of traffic must be handled on the fast-path in order to keep up with network traffic and to avoid being a bottleneck. To keep up with the data flow fast-path operations have always been limited both in number and in scope. There are five basic operations that have traditionally been fast-path operations: framing/parsing, classification, modification, encryption/compression, and queuing.

Traditionally the fast-path operations have been performed by a general purpose microprocessor or custom ASICs. However, in order to provide some programmability while maintaining speed requirements, many companies have recently introduced highly specialized network processors (NPUs) to operate on the fast-path data stream. While NPUs are able to operate at the same data rates as ASICs, such as OC-12, OC-48 and OC-192, they provide some level of programmability. Even with state of the art NPUs, however, fast-path operations must still be limited to specific, well-defined operations that operate only on very specific fields within the data packets. None of the current network devices, even those employing NPUs, are able to delve deep into a packet, beyond simple header information and into the packet contents while on the fast-path of data flow. The ability to look beyond the header information while still in the fast-path and into the packet contents would allow a network device to identify the nature of the information carried in the packet, thereby allowing much more detailed packet classification. Knowledge of the content would also allow specific contents to be identified and scanned to provide security such as virus detection, denial of service (DoS) prevention, etc. Further, looking deeper into the data packets and being able to maintain an awareness of content over an entire traffic flow would allow for validation of network traffic flows, and verification of network protocols to aid in the processing of packets down stream.

In order to look beyond the header information of an IP data packet, the incoming data stream must be compared against signatures, or patterns, which determine whether the information being looked for is actually in the traffic flowing through the network. For example, if an internet service provider wanted to enforce the terms of a service level agreement, instead of just monitoring for service failures, it would have to be able to identify traffic coming from the customer of the service level agreement. In addition, it would have to be able to distinguish between the types of traffic coming from the customer, such as the difference between web traffic, email and streaming traffic such as voice calls. To do this the internet service provider, or any network operator, would need to be able to recognize patterns in the network traffic that tell it which traffic belongs to the customer and what type of traffic it is. This is done by looking for patterns in the traffic that correspond to the customer and traffic type.

This can be done in software, but only by removing the traffic from the network flow, which would be fatal in the case of real time traffic such as voice calls. In order to be able to accomplish this the traffic must be scanned, identified, associated into flows, and treated to alter the characteristics of the network in real time.

Accordingly, what is needed is a network device that can look beyond simple header information and into the packet contents or payload, to be able to scan the payload on the fast-path at wire speeds beyond 1 gigabit per second, and to be able to maintain state information or awareness throughout an entire data traffic flow.

### SUMMARY OF THE INVENTION

The present invention provides for a method of matching patterns in an IP data stream. The method breaks in incoming IP data stream into one or more contexts which are then sent to rake engine which determines whether the incoming IP data stream has any potential matches in a database of known signatures. If a potential match is identified, a ruler engine then determines whether the incoming IP data stream and the potentially matching signature match exactly. The method is able match complex patterns across IP packet boundaries by scanning the entire contents of data packets forming a network data flow, the contents of data packets including both header and payload information. To make the method more efficient, multiple contexts, each belonging to a different session, are processed simultaneously. Once scheduled, the contexts are sent to the pattern matching engine to be scanned. The method may also include simplifying the string for scanning by compressing white space, etc.

The method may also include, before scanning, retrieving state information related to the flow being scanned from a session memory. The state information contains all information related to the flow and incomplete matches that have already been determined through previous scanning. The state information allows scanning across packet boundaries.

A conclusion is generated in response to the scanning by the pattern matching engine. The conclusion is programmable and can represent any information or instruction desired by the user. In general the conclusion will indicate one of a number of likely scenarios. For example, the conclusion will indicate that more scanning is required using the next block of data, that an action, or instruction, needs to be performed by the outside the pattern matching engine, such as that information needs to be sent to the host processor for further processing, or when scanning is complete, that the packet is ready to be sent with the conclusion, such as a treatment representing routing and quality of service treatment for the data packet.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art will appreciate that they can readily use the disclosed conception and specific embodiment as a basis for designing or modifying other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a network topology diagram showing example environments in which the present invention may operate;

FIG. 2 illustrates a block diagram of an embodiment of a single blade network apparatus constructed according to the principles of the present invention;

FIG. 3 illustrates a block diagram of an embodiment of the content processor from FIG. 2;

FIG. 4 illustrates an embodiment of the pattern matching engine from FIG. 3;

FIG. 5 illustrates a diagram of an embodiment of a rake engine pipeline;

FIG. 6 illustrates a diagram of an embodiment of a ruler engine pipeline; and

FIG. 7 illustrates a flow diagram of an embodiment of a method of matching an incoming data stream.

### DETAILED DESCRIPTION OF THE DRAWINGS

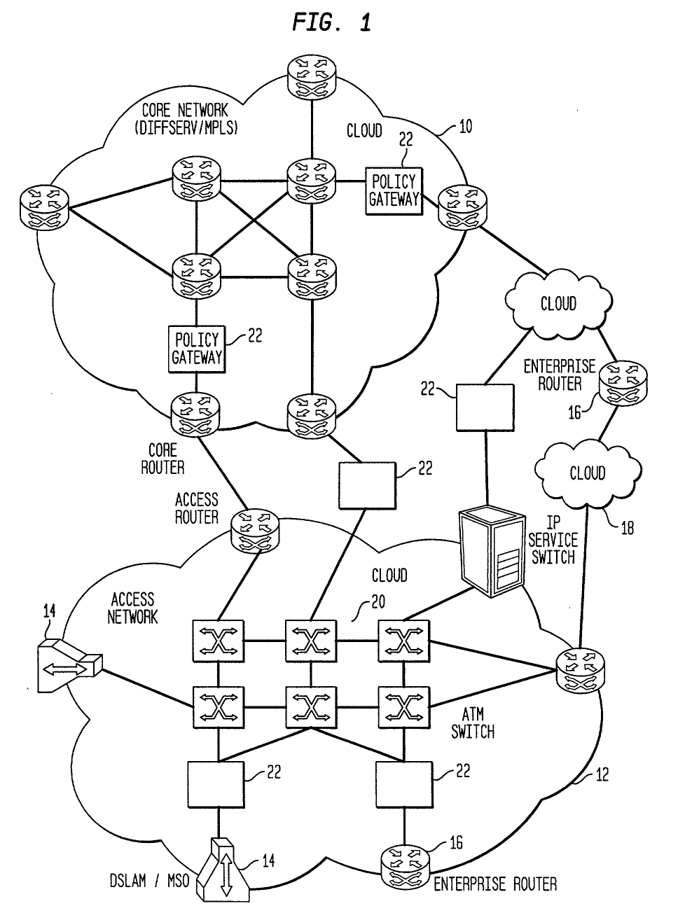

Referring now to FIG. 1, a network topology is shown which is an example of several network infrastructures that connect in some manner to a broader public IP network 10 such as the Internet. FIG. 1 is in no way meant to be a precise network architecture, but only to serve as a rough illustration of a variety of network structures which can exist on a broadband IP network. Public IP network 10 can be accessed in a variety of ways. FIG. 1 shows the public IP network being accessed through a private IP network 12 which can be the IP network of a company such as MCI or UUNET which provide private core networks. An endless variety of network structures can be connected to private IP network 12 in order to access other networks connected to private IP network 12 or to access public IP network 10.

One example of a network structure connecting to private IP network 12 is hosting network 14. Hosting network 14 is an example of a network structure that provides hosting services for Internet websites. These hosting services can be in the form of webfarm 16. Webfarm 16 begins with webservers 30 and database 32 which contain the webpages, programs and databases associated with a particular website such as Amazon.com or Yahoo.com. Webservers 30 connect to redundant load balancers 28 which receive incoming Internet traffic and assign it to a particular webserver to balance the loads across all of webservers 30. Redundant intrusion detection systems 26 and firewalls connect to load balancers 28 and provide security for webfarm 16. Individual webfarms 16 and 17 connect to hosting network 14's switched backbone 18 by means of a network of switches 20 and routers 22. Hosting network 14's switched backbone 18 is itself made up of a network of switches 20 which then connect to one or more routers 22 to connect to private IP network 12. Connections between individual webfarms 16 and 17 and the switched backbone 18 of hosting network 14 are usually made at speeds such as OC-3 or OC-12 (approx. 150 megabits/sec or 625 megabits/sec), while the connection from router 22 of hosting network 14 to private IP network 12 are on the order OC-48 speeds (approx. 2.5 gigabits/sec).

Another example of network structures connecting to private IP network are illustrated with service provider network 34. Service provider network 34 is an example of a network structure for Internet Service Providers (ISPs) or Local Exchange Carriers (LECs) to provide both data and voice access to private IP network 12 and public IP network 10. Service provider network 34 provides services such as Internet and intranet access for enterprise networks 36 and 37. Enterprise networks 36 and 37 are, for example, company networks such as the company network for Lucent Technologies or Merrill Lynch. Each enterprise network, such as enterprise network 36, includes a plurality of network servers and individual workstations connected to a switched backbone 18, which can be connected by routers 22 to service provider network 34.

In addition to Internet access for enterprise networks, service provider network 34 provides dial-up Internet access for individuals or small businesses. Dial-up access is provided in service provider network 34 by remote access server (RAS) 42, which allows personal computers (PCs) to call into service provider network 34 through the public switched telephone network (PSTN), not shown. Once a connection has been made between the PC 50 and RAS 42 through the PSTN, PC 50 can then access the private or public IP networks 12 and 10.

Service provider network 34 also provides the ability to use the Internet to provide voice calls over a data network referred to as Voice over IP (VoIP). VoIP networks 46 and 47 allow IP phones 48 and PCs 50 equipped with the proper software to make telephone calls to other phones, or PCs connected to the Internet or even to regular phones connected to the PSTN. VoIP networks, such as VoIP network 46, include media gateways 52 and other equipment, not shown, to collect and concentrate the VoIP calls which are sent through service provider network 34 and private and public Internet 12 and 10 as required. As mentioned, the advent of VoIP as well as other real time services such as video over the Internet make quality of service a priority for service providers in order to match the traditional telephone service provided by traditional telephone companies.

Service provider network 34 includes a switched backbone 18 formed by switches 20 as well as routers 22 between it and its end users and between it and private IP network 12. Domain name servers 44 and other networking equipment, which are not shown, are also included in service provider network 34. Similar to hosting network 34, connection speeds for service provider network 34 can range from speeds such as T1, T3, OC-3 and OC-12 for connecting to enterprise networks 36 and 37 as well as VoIP networks 46 and 47 all the way to OC-48 and conceivably even OC-192 for connections to the private IP network.

It can easily be seen that aggregation points 60 exist at the edges of these various network structures where data is passed from one network structure to another at speeds such as OC-3, OC12, and OC-48. One major problem in the network structures shown in FIG. 1 is the lack of any type of intelligence at these aggregation points 60 which would allow the network to provide services such as security, metering and quality of service. The intelligence to provide these services would require that the network understand the type of data passing through the aggregation points 60 and not just the destination and/or source information which is currently all that is understood. Understanding the type of data, or its contents, including the contents of the associated payloads as well as header information, and further understanding and maintaining a state awareness across each individual traffic flow would allow the network to configure itself in real time to bandwidth requirements on the network for applications such as VoIP or video where quality of service is a fundamental requirement. An intelligent, or “content aware”, network would also be able to identify and filter out security problems such as email worms, viruses, denial of service (DoS) attacks, and illegal hacking in a manner that would be transparent to end users. Further, a content aware network would provide for metering capabilities by hosting companies and service providers, allowing these companies to regulate the amount of bandwidth allotted to individual customers as well as to charge precisely for bandwidth and additional features such as security.

In accordance with the requirements set forth above, the present invention provides for a network device that is able to scan, classify, and modify network traffic including payload information at speeds of OC-3, OC-12, OC-48 and greater thereby providing a “content aware” network.

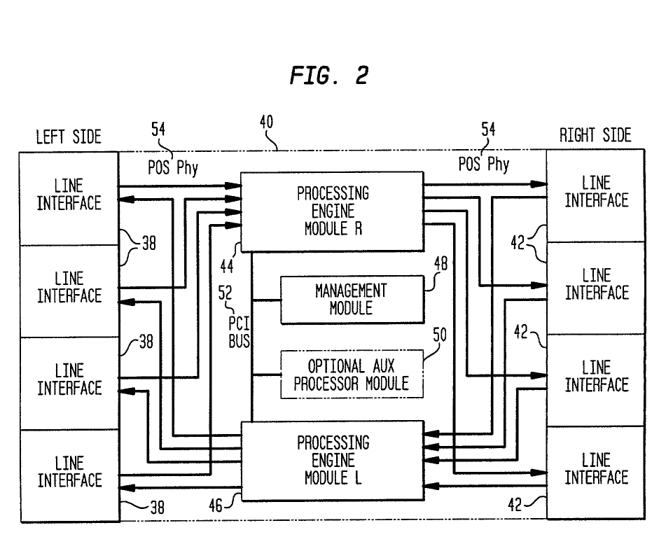

Referring now to FIG. 2, one embodiment of a network apparatus according to the present invention is shown. Network apparatus 100, as shown, accepts data received from a high-speed network line or lines, processes the data, and then places the data back on a line or lines. Network apparatus 100 accepts data from the line by means of input physical interface 102. Input physical interface 102 can consist of a plurality of ports, and can accept any number of network speeds and protocols, including such high speeds as OC-3, OC-12, OC-48, and protocols including 10/100 Ethernet, gigabit Ethernet, and SONET. Input physical interface 102 takes the data from the physical ports, frames the data, and then formats the data for placement on fast-path data bus 126 which is preferably an industry standard data bus such as a POS-PHY Level 3, or an ATM UTOPIA Level 3 type data bus.

Fast-path data bus 126 feeds the data to traffic flow scanning processor 140, which includes header preprocessor 104 and content processor 110. The data is first sent to header preprocessor 104, which is operable to perform several operations using information contained in the data packet headers. Header preprocessor 104 stores the received data packets in packet storage memory 106 and scans the header information. The header information is scanned to identify the type, or protocol, of the data packet, which is used to determine routing information and to decode the IP header starting byte. As will be discussed below, network apparatus 100, in order to function properly, needs to reorder out of order data packets and reassemble data packet fragments. Header preprocessor 104 is operable to perform the assembly of asynchronous transfer mode (ATM) cells into complete data packets (PDUs), which could include the stripping of ATM header information.

After data packets have been processed by header preprocessor 104 the data packets, any conclusion formed by the header preprocessor, such as QoS information, are sent on fast-data path 126 to the other half of traffic flow scanning engine 140, content processor 110. The received packets are stored in packet storage memory 112 while they are processed by content processor 110. Content processor 110 is operable to scan the contents of data packets received from header preprocessor 104, including the entire payload contents of the data packets. The header is scanned as well, one goal of which is to create a session id using predetermined attributes of the data packet.

In the preferred embodiment, a session id is created using session information consisting of the source address, destination address, source port, destination port and protocol, although one skilled in the art would understand that a session id could be created using any subset of fields listed or any additional fields in the data packet without departing from the scope of the present invention. When a data packet is received that has new session information the header preprocessor creates a unique session id to identify that particular traffic flow. Each successive data packet with the same session information is assigned the same session id to identify each packet within that flow. Session ids are retired when the particular traffic flow is ended through an explicit action, or when the traffic flow times out, meaning that a data packet for that traffic flow has not been received within a predetermined amount of time. While the session id is discussed herein as being created by the header preprocessor 104 the session id can be created anywhere in traffic flow scanning engine 140 including in content processor 110.

The scanning of the header by content processor 110 also allows network apparatus 100 to perform routing functions. Routing tables and information can be stored in database memory 112. Routing instructions received by network apparatus 100 are identified, recorded and passed to microprocessor 124 by content processor 110 so that microprocessor 124 is able to update the routing tables in database memory 112 accordingly. While network apparatus 100 is shown as a single blade apparatus, the input and the output could be formed by multiple lines, for example four OC-12 lines could be connected to network apparatus 100 which operates at OC-48 speeds. In such a case, single blade network apparatus 100 will have limited routing or switching capabilities between the multiple lines, although the switching capability will be less than in a conventional router or switch. Additionally, a network apparatus can be constructed according to the principles of the present invention, which is able to operate as a network router or switch.

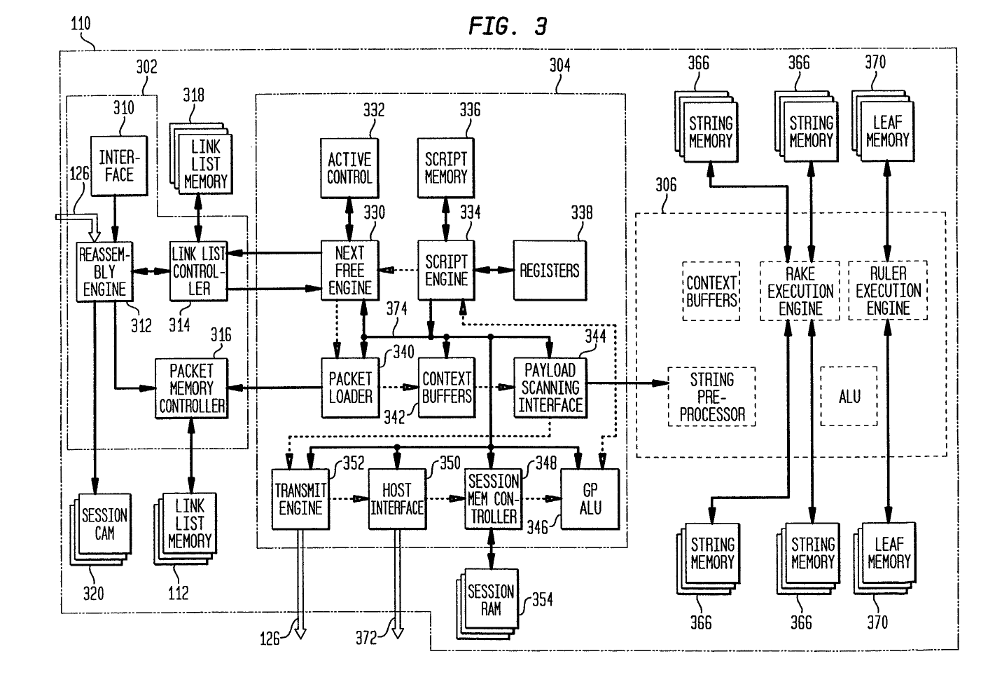

The contents of any or all data packets are compared to a database of known signatures and if the contents of a data packet, or packets, match a known signature, an action associated with that signature and/or session id can be taken by network apparatus 100. Additionally, content processor 110 is operable to maintain state awareness throughout each individual traffic flow. In other words, content processor 110 maintains a database for each session which stores state information related to not only the current data packets from a traffic flow, but state information related to the entirety of the traffic flow. This allows network apparatus 100 to act on not only based on the content of the data packets being scanned but also based on the contents of the entire traffic flow. The specific operation of content processor 110 will be described with reference to FIG. 3.

Once the contents of the packets have been scanned and a conclusion reached by traffic flow scanning engine 140, the packets and the associated conclusions of either or both the header preprocessor and the content processor are sent to quality of service (QoS) processor 116. QoS processor 116 again stores the packets in its own packet storage memory 118 for forwarding. QoS processor 116 is operable to perform the traffic flow management for the stream of data packets processed by network apparatus 100. QoS processor contains engines for traffic management 126, traffic shaping 128 and packet modification 130.

QoS processor 116 takes the conclusion of either or both of header preprocessor 104 and content processor 110 and assigns the data packet to one of its internal quality of service queues 132 based on the conclusion. The quality of service queues 132 can be assigned priority relative to one another or can be assigned a maximum or minimum percentage of the traffic flow through the device. This allows QoS processor to assign the necessary bandwidth to traffic flows such as VoIP, video and other flows with high quality and reliability requirements while assigning remaining bandwidth to traffic flows with low quality requirements such as email and general web surfing to low priority queues. Information in queues that do not have the available bandwidth to transmit all the data currently residing in the queue according to the QoS engine is selectively discarded thereby removing that data from the traffic flow.

The quality of service queues 132 also allow network apparatus 100 to manage network attacks such as denial of service (DoS) attacks. Network apparatus 100 can act to qualify traffic flows by scanning the contents of the packets and verifying that the contents contain valid network traffic between known sources and destinations. Traffic flows that have not been verified because they are from unknown sources or because they are new unclassified flows can be assigned to a low quality of service queue until the sources are verified or the traffic flow classified as valid traffic. Since most DoS attacks send either new session information, data from spoofed sources, or meaningless data, network apparatus 100 would assign those traffic flows to low quality traffic queues. This ensures that the DoS traffic would receive no more than a small percentage (i.e. 5%) of the available bandwidth thereby preventing the attacker from flooding downstream network equipment.

The QoS queues 132 in QoS processor 116 (there are 65 k queues in the present embodiment of the QoS processor although any number of queues could be used) feed into schedulers 134 (1024 in the present embodiment), which feed into logic ports 136 (256 in the present embodiment), which send the data to flow control port managers 138 (32 is the present embodiment) which can correspond to physical egress ports for the network device. The traffic management engine 126 and the traffic shaping engine 128 determine the operation of the schedulers and logic ports in order to maintain traffic flow in accordance with the programmed parameters.

QoS processor 116 also includes packet modification engine 130, which is operable to modify, add, or delete bits in any of the fields of a data packet. This allows QoS processor 116 to change addresses for routing or to place the appropriate headers on the data packets for the required protocol. The packet modification engine 130 can also be used to change information within the payload itself if necessary. Data packets are then sent along fast-data path 126 to output PHY interface 120 where it is converted back into an analog signal and placed on the network.

As with all network equipment, a certain amount of network traffic will not be able to be processed along fast-data path 126. This traffic will need to be processed by on board microprocessor 124. The fast-path traffic flow scanning engine 140 and QoS processor 116 send packets requiring additional processing to flow management processor 122, which forwards them to microprocessor 124 for processing. The microprocessor 124 then communicates back to traffic flow scanning engine 140 and QoS processor 116 through flow management processor 122. Flow management processor 122 is also operable to collect data and statistics on the nature of the traffic flow through network apparatus 100. In addition to processing odd, or missing packets, microprocessor 124 also controls the user management interface 142 and recompiles databases 108 and 114 to accommodate new signatures and can be used to learn and unlearn sessions identified by the traffic flow scanning engine 140.

As can be seen from the description of FIG. 2, network apparatus 100 allows the entire contents of any or all data packets received to be scanned against a database of known signatures. The scanned contents can be any variable or arbitrary length and can even cross packet boundaries. The abilities of network apparatus 100 allow the construction of a network device that is content aware which gives the network device the ability to operate on data packets based on the content of that data packet.

Referring now to FIG. 3, the content processor 110 of FIG. 2 is described in greater detail. As described above content processor 110 is operable to scan the contents of data packets forwarded from header preprocessor 104 from FIG. 2. Content processor 110 includes three separate engines, queue engine 302, context engine 304, and pattern matching engine 306.

Since content processor 110 scans the contents of the payload, and is able to scan across packet boundaries, content processor 110 is able to reassemble fragmented packets and reorder out-of-order packets on a per-session basis. Reordering and reassembling is the function of queue engine 302. Queue engine 302 receives data from fast-path data bus 126 using fast-path interface 310. Packets are then sent to packet reorder and reassembly engine 312, which uses packet memory controller 316 to store the packets into packet memory 112. Reordering and reassembly engine 312 also uses link list controller 314 and link list memory 318 to develop detailed link lists that are used to order the data packets for processing. The data packets are broken into 256 byte blocks for storage within the queue engine 302. Session CAM 320 can store the session id generated by queue engine 302 of content processor 110. Reordering and reassembly engine 312 uses the session id to link data packets belonging to the same data flow.

In order to obtain the high throughput speeds required, content processor 110 must be able to process packets from multiple sessions simultaneously. Content processor 110 processes blocks of data from multiple data packets each belonging to a unique traffic flow having an associated session id. In the preferred embodiment of the present invention, context engine 304 of content processor 110 processes 64 byte blocks of 64 different data packets from unique traffic flows simultaneously. Each of the 64 byte blocks of the 64 different data flows represents a single context for the content processor. The scheduling and management of all the simultaneous contexts for content processor 110 is handled by context engine 304.

Context engine 304 works with queue engine 302 to select a new context when a context has finished processing and has been transmitted out of content processor 110. Next free context/next free block engine 330 communicates with link list controller 314 to identify the next block of a data packet to process. Since content processor 110 must scan data packets in order, only one data packet or traffic flow with a particular session id can be active at one time. Active control list 332 keeps a list of session ids with active contexts and checks new contexts against the active list to insure that the new context is from an inactive session id. When a new context has been identified packet loader 340 uses the link list information retrieved by the next free context/next free block engine 330 to retrieve the required block of data from packet memory 112 using packet memory controller 316. The new data block is then loaded into a free buffer from context buffers 342 where it waits to be retrieved by payload scanning interface 344. Payload scanning interface 344 is the interface between context engine 304 and the pattern matching engine 306.

The pattern matching engine 306 enables content scanning and can process up to 64 PDUs making conclusions simultaneously and can save state across PDUs for up to one million sessions. the pattern matching engine 306 executes program instructions employing two types of execution engines, a rake execution engine and a ruler execution engine. The rake execution engine may be used to quickly traverse a collection of string memories 366 to differentiate between known strings to produce a best estimate or potential pattern match to known signatures contained in the string memories 366. The ruler execution engine employs a collection of leaf memories 370 to verify the outcome of the rake execution engine and to save state information until a conclusion is reached. Both the rake and ruler execution engines are pipelined engines that can process up to four different contexts in their pipelines. Additionally, four rake and ruler execution engines typically may be implemented in the pattern matching engine 306.

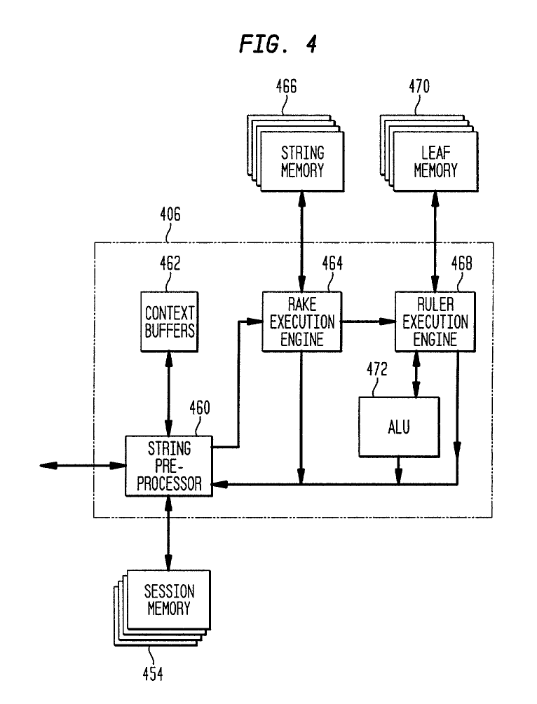

A string pre-processor is employed in the pattern matching engine 306 to receive PDU data from the payload scanning interface 344 in a 64 byte format. This data, along with a processing state, is stored locally in context buffers. The string pre-processor passes this formatted data to the rake and ruler execution engines in the form of an 8-byte payload window. An arithmetic logic unit (ALU) employs a simple instruction set computer language to execute a majority of the ALU instructions associated with the ruler execution engine When all of the formatted data has been processed, the string pre-processor will request more data from the payload scanning interface 344. The pattern matching engine 306 is discussed further with respect to FIG. 4.

The conclusions associated with the content scanning are then sent back to the payload scanning interface 344 along with possibly a request for new data to be scanned. The conclusion of the content scanning can be any of a number of possible conclusions. The scanning may not have reached a conclusion yet and may need additional data from a new data packet to continue scanning in which case the state of the traffic flow, which can be referred to as an intermediate state, and any incomplete scans are stored in session memory 354 along with other appropriate information such as sequence numbers, counters, etc.

The conclusion reached by string memory 366 may also be that scanning is complete and there is or is not a match, in which case the data packet and the conclusion are sent to transmit engine 352 for passing to QoS processor 116 from FIG. 2. The scanning could also determine that the data packet needs to be forwarded to microprocessor 124 from FIG. 2 for further processing, so that the data packet is sent to host interface 350 and placed on host interface bus 372. In addition to handling odd packets, host interface bus 350 allows microprocessor 124 to control any aspect of the operation of content processor 110 by letting microprocessor 124 write to any buffer or register in context engine 304. State information is stored in session memory 354 and is updated as necessary after data associated with the particular traffic flow is scanned.

The operation of transmit engine 352, host interface 350, session memory controller 348, which controls the use of session memory 354, and of general-purpose arithmetic logic unit (GP ALU) 346, which is used to increment or decrement counter, move pointers, etc., is controlled by script engine 334. Script engine 334 operates to execute programmable scripts stored in script memory 336 using registers 338 as necessary. Script engine 334 uses control bus 374 to send instruction to any of elements in context engine 304. Script engine 334 or other engines within content processor 100 have the ability to modify the contents of the data packets scanned. For example, viruses can be detected in emails scanned by content processor 100, in which case the content processor can act to alter the bits of infected attachment essentially rendering the email harmless.

The abilities of content processor 110 are unique in a number of respects. Content processor 110 has the ability to scan the contents of any data packet or packets for any information that can be represented as a signature or series of signatures. The signatures can be of any arbitrary length, can begin and end anywhere within the packets and can cross packet boundaries. Further, content processor 110 is able to maintain state awareness throughout all of the individual traffic flow by storing state information for each traffic flow representing any or all signatures matched during the course of that traffic flow. Existing network processors operate by looking for fixed length information at a precise point within each data packet and cannot look across packet boundaries. By only being able to look at fixed length information at precise points in a packet, existing network processors are limited to acting on information contained at an identifiable location within some level of the packet headers and cannot look into the payload of a data packet much less make decisions on state information for the entire traffic flow or even on the contents of the data packet including the payload.

Referring now to FIG. 4, an embodiment of the pattern matching engine 306 of FIG. 3 is described in greater detail. In FIG. 4, a pattern matching engine 406 is employed for matching an incoming data stream of IP packets to a database of known signatures and provides an embodiment of the pattern matching engine 306. The pattern matching engine 406 includes a string preprocessor 460, a context buffer 462, a rake execution engine 464, a ruler execution engine 468 and an ALU 472. Additionally, the string pre-processor 460 is coupled to a session memory 454, the 15; rake execution engine 464 is coupled to a string memory 466 and the ruler execution engine 470 is coupled to a leaf memory 470.

The rake execution engine 464 includes a rake scheduler RakeS and a rake engine RakeE having four banks that are operable to compare the incoming data stream to the database of known signatures to determine a potential pattern match. The payload scanning interface 344 sends data to the pattern matching engine 406 in the form of data-chunks, which may be up to 64 bytes in length. The string pre-processor 460 stores this data in the context buffer 462 until it can be passed to the rake scheduler RakeS. The rake scheduler RakeS monitors the four rake engine RakeE banks and as they become available, the rake scheduler RakeS removes a context from the queue and forwards it to the open rake engine RakeE.

The rake engine RakeE receives the context from the rake scheduler RakeS and examines its address space. If the context has a rake engine RakeE address space, it will execute a simple instruction set computer (SISC) instruction from the string memory 466. Based on the executed instruction, the context will either execute another rake engine RakeE instruction or be passed to either the ruler execution engine 468 or the string pre-processor 460. A context is passed to the ruler execution engine 468 if its address space is switched to ruler space. A context is passed to the string pre-processor 460 if the rake engine RakeE requires a new payload window.

The string memory 466 is assigned the context by the rake execution engine 464, which then compares the significant bits of the context to the database of known signatures that reside in the string memory 466. The string memory 466 determines whether there is a potential match between the context and one of the known signatures using significant bits, which are those bits that are unique to a particular signature. If there is a potential match, the context and the potentially matched string are sent to the ruler execution engine 468, which uses leaf memory 470 to perform a bit to bit comparison of the context and the potentially matched string.

The ruler execution engine 468 includes a ruler scheduler RulerS and a ruler engine RulerE having four banks that are operable to further define an exact pattern match from the potential pattern match achieved in the ruler engine RulerE. The ruler scheduler RulerS monitors the ruler engine RulerE for an open bank. When a bank is available, the ruler scheduler RulerS fetches eight SISC instructions from the leaf memory 470 that are forwarded along with the context to the open ruler engine RulerE. The ruler engine RulerE takes incoming contexts and inserts them into its pipeline. The context then executes ruler instructions until a new payload window is needed, its address space is changed to a rake space or more ruler instructions are needed. At this time, the ruler execution engine 468 passes the context to the string pre-processor 460.

When the string pre-processor 460 receives a context from either the rake execution engine 464 or the ruler execution engine 468, it saves its state to the context buffers 462. If the context has reached the end of the data-chunk, the string pre-processor 460 requests a new data-chunk from the payload scanning interface 344. Otherwise, the context is queued again for the rake scheduler RakeS. Additionally, the string pre-processor 460 is operable to simplify the context by performing operations such as compressing white space (i.e. spaces, tabs, returns) into a single space to simplify scanning.

The context buffers 462 are a collection of register files that store information required to process a context. This includes work space information, 64 bytes of chunk data and registers for the ruler execution engine 468. The ALU 472 is a pipelined unit coupled to the ruler execution engine 468 wherein a first stage decodes instructions and reads internal register files. A second stage multiplexes 32 outputs from each register file and prepares both operands and flags for the following execution stage. A third stage executes the ALU 472 instruction, and a fourth stage writes back to both register files that are internal to the ALU 472 and external in the context buffer 462.

Although only one string memory 466 is shown in the illustrated embodiment (and four string memories 366 are shown in FIG. 3), each is potentially capable of handling multiple contexts. Any number may be used to optimize the throughput through the content processor 110. In the present embodiment, the string memory 466 is capable of processing four contexts at one time. Similarly, although one leaf memory 470 is shown in the illustrated embodiment (and two leaf memories 370 are shown in FIG. 3) each is potentially capable of handling multiple contexts. Any number may be used to optimize the throughput through content processor 110.

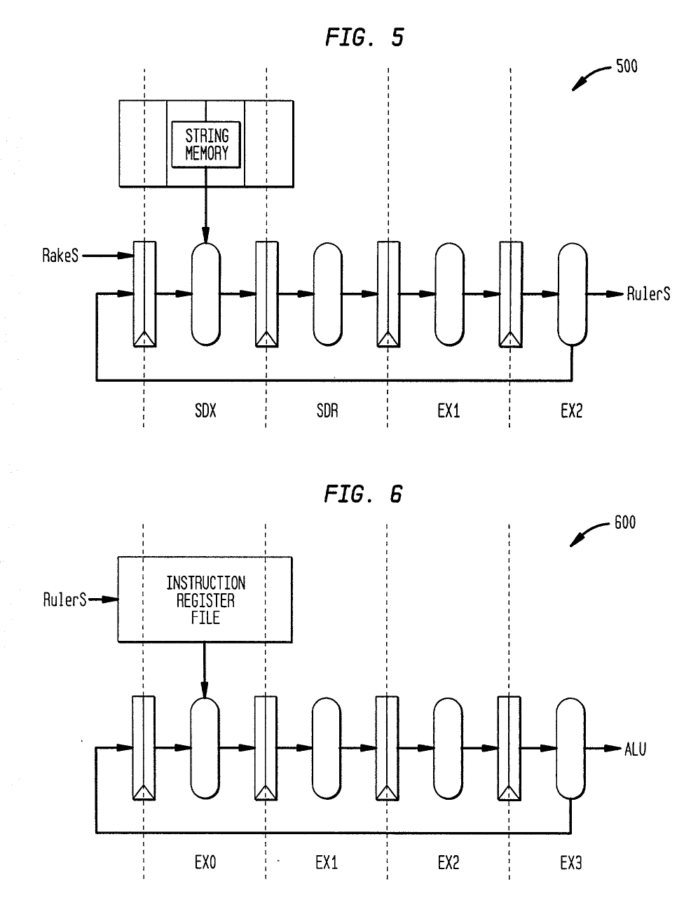

Referring now to FIG. 5, illustrated is a diagram of an embodiment of a rake engine pipeline, generally designated 500. Contents sent by the string pre-processor are queued by the rake scheduler until it can service them. When a rake engine becomes available, the rake scheduler checks for conflicts between the context and open rake engines. If there are no conflicts, the context is moved from the queue and passed to the selected rake engine. The rake engine pipeline 500 includes four stages SDX, SDR, EX1, EX2. The stage SDX is used primarily to access a string memory and to issue all session memory commands. The stage SDR is employed to retrieve data from the string memory and to pass it to the stage EX1. The stage EX1 decodes the instruction for the rake engine and the stage EX2 redirects the context to the stage SDX, directs it to the string preprocessor or to the ruler scheduler for further processing.

A typical data flow operation in a scan mode encompasses a rake engine receiving a valid context from the rake scheduler. Then, an open row instruction is initiated into the SDX stage for its associated bank, and after a latency period elapses it places a read instruction following the open command. Next, the context is passed to the SDR stage wherein the SDR stage waits for a rake instruction to return from the read bus of the string memory. After the read bus is valid, the SDR stage forwards the context and the newly read instruction to the EX1 stage along with a set of data such as payload, register information or data bank number that is associated with the context. The rake instruction is decoded in the EX1 stage, associated fields for the context are updated according to the instruction and the instruction is directed toward the payload. A decision is made in the EX1stage regarding three data flow situations.

The first situation is whether the context needs to feedback to the SDX stage and to start on the next rake instruction from a different column location in the same row of the same bank. The second situation determines whether the context needs to exit the rake engine and return to the string pre-processor either to start a new instruction in a different row of the string memory or to request more valid payload bytes. The third situation determines whether the context needs to leave the rake engine and proceed to the ruler execution engine for further processing.

The last stage EX2 directs the context to one of these possible paths. If the context needs to loop back to the SDX stage, the open row operation is skipped and the read command is placed into the SDX instruction register directly since the string memory row in the bank is already active. If the context needs to exit to either the string pre-processor or the ruler scheduler, the EX2 stage issues a precharge command to the SDX stage so that an appropriate string memory command may be sent to precharge the row in the bank. A rake execution engine journey of the context is not complete until the precharge operation is finished or another valid context from the rake scheduler can be processed to use this bank.

Referring now to FIG. 6, illustrated is a diagram of an embodiment of a ruler engine pipeline, generally designated 600. The ruler scheduler controls the flow of contexts from the rake engine to the ruler engine. Contexts are queued in the ruler scheduler until a slot becomes available in the ruler engine. Then eight instructions are pre-fetched from an instruction register file in the leaf memory and passed with the context to the ruler engine.

The ruler engine pipeline 600 includes four stages EX0, EX1, EX2, EX3 wherein a different context may be active in each of these stages thereby allowing up to four active contexts in each ruler execution engine. The main function of the EX0 stage is to fetch the next instruction from the instruction register file. The EX0 stage is also responsible for converting all ASCII values to lower case if a case insensitive match is fetched. The EX1 stage performs the instruction decode, and the EX2 stage performs matches and skips. The EX2 stage determines if the current instruction has all the data it needs within the current payload window. If not, appropriate registers are updated and an exit to the string pre-processor is signaled. Finally, the EX3 stage passes the context to the string pre-processor if completed, feeds it back to the EX0 stage or passes instructions on to the ALU as required.

As a pipeline, the ruler engine executes ruler SISC instructions that are used to precisely match a SISC argument or to resolve a particular subnet. Instruction types for the ruler engine include Match, Skip, ALU, Action and Continue. For example, Match types include RUMA, which matches one to 255 bits and RUMB, which matches 24 to 56 bits. Match types also include RUXA, which jumps to one of five locations based on the number of bits matched by the last RUMA or RUMB. Skip types include RUSKI and RUSKY, which skips zero to 127 bits and skips zero to 127 bytes, respectively. Continue types include RUCRA and RUCRU, which jump to rake addresses and jump to ruler addresses, respectively. Action types include RUACT, which issues a payload scanning interface command. ALU types provide the means to write into the register bank and to do simple manipulation and compares in the ALU, as needed.

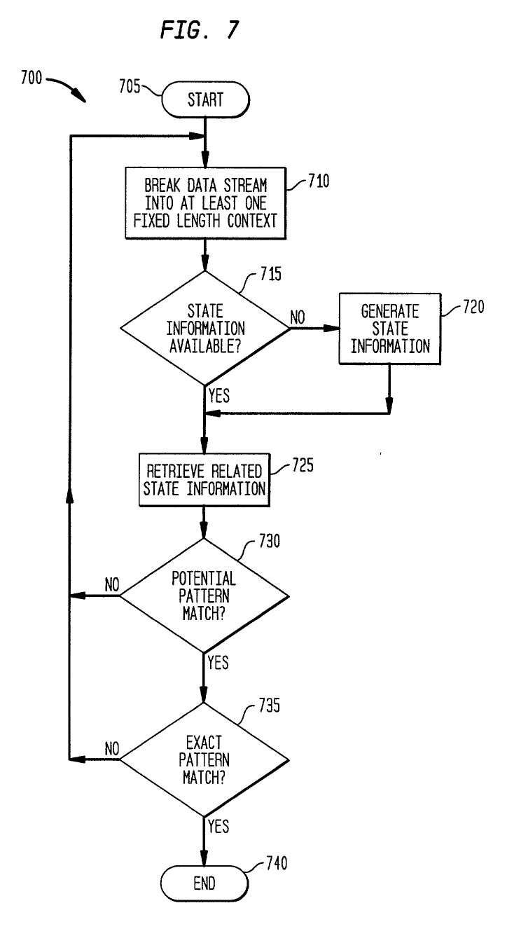

Referring now to FIG. 7, illustrated is a flow diagram of an embodiment of a method of matching an incoming data stream, generally referenced as 700. The method 700 starts in a step 705 with an intent to pattern match an incoming data stream of IP packets to a database of known signatures stored in memory. The data stream is broken into at least one fixed length context in a step 710. Then in a first decisional step 715, the method 700 determines if state information is available. The state information of the step 715 is related not only to the current data packets from the data stream or a traffic flow but may be state information related to the entire data stream or traffic flow. If the state information is not available in the step 715, the state information is generated in a step 720.

Then, in a step 725, the state information related to the incoming data stream is retrieved. The method 700 proceeds to a second decisional step 730 wherein a determination is made as to whether the context has a potential match in the database of known signatures. If there are no potential matches in the step 730, the method 700 returns the step 705 for further processing and the current state information is maintained in an associated session database. Alternatively during pattern matching, the state information may indicate that the state is an intermediate state, representing that the matching is incomplete and additional data is needed to continue the scanning. Also, the state may be a partial state indicating that one or more events have occurred from a plurality of events required to generate a particular conclusion.

A successful conclusion to the second decisional step 730 indicating that a potential pattern match to a known signature has been achieved and leads to a third decisional step 735. The third decisional step 735 determines if the identified potential match has an exact pattern match in the database of known signatures. If there is no exact pattern match in the step 735, the method 700 again returns the step 705 for further processing and the current state information is maintained in the associated session database. If an exact pattern match is found in the third decisional step 735, the current state information is maintained in the associated session database and the method 700 ends in a step 740.

The state information may be a final state indicating that a final conclusion has been reached for the associated traffic flow and no further scanning is necessary. Alternatively, the state information may represent any other condition required or programmed into a content processor such as the content processor 110 associated with FIG. 3. The state information for each traffic flow, in whatever form, represents the content awareness of a network apparatus such as the network apparatus 100 associated with FIG. 2, and allows the network apparatus to act not only on the information scanned, but also on all the information that has been previously scanned for each traffic flow.

Although the present invention has been described in detail, those skilled in the art should understand that they can make various changes, substitutions and alterations herein without departing from the spirit and scope of the invention in its broadest form.

What is claimed is:

1. A method for matching an incoming data stream in the form of IP packets to a database of known signatures stored in memory, the method comprising:
breaking the incoming data stream into at least one fixed length context;
retrieving state information related to the incoming data stream;
determining, by using the state information in conjunction with the incoming data stream, whether the context has any potential pattern matches in the database of known signatures; and
determining, when a potential pattern match has been identified, whether the context has an exact pattern match from the potential pattern match.

2. The method as recited in claim 1 further comprising storing state information related to the potential and exact pattern matches.

3. The method as recited in claim 2 wherein pattern matching occurs across at least one IP packet boundary.

4. The method as recited in claim 1 wherein multiple contexts are processed in parallel substantially simultaneously.

5. The method as recited in claim 1 wherein potential and exact pattern matching includes scheduling and pipeline processing.

6. The method as recited in claim 1 wherein the matching is performed by a pattern matching engine comprising a rake engine to determine potential matches and a ruler engine to determine exact matches.

7. A method for matching an incoming data stream in the form of IP packets to a database of known signatures stored in memory, the method comprising:
identifying a flow associated with the IP packet being scanned;
retrieving state information related to the particular flow;
determining, by using the state information and the IP packet being scanned, whether the context has any potential pattern matches in the database of known signatures; and
determining, when a potential pattern match has been identified, whether the context has an exact pattern match from the potential pattern match;
determining a conclusion based on the results of the scan.

8. The method as recited in claim 7 further comprising updating state information based on the results of the scanning.

9. The method as recited in claim 7 wherein pattern matching occurs at least one IP packet boundary.

10. The method as recited in claim 7 wherein after identifying the method includes breaking the incoming data stream into at least one fixed length context

11. The method as recited in claim 7 wherein multiple contexts are processed in parallel substantially simultaneously.

12. The method as recited in claim 7 wherein potential and exact pattern matching includes scheduling and pipeline processing.

13. The method as recited in claim 7 wherein the matching is performed by a pattern matching engine comprising a rake engine to determine potential matches and a ruler engine to determine exact matches.
